(19) United States
(12) Patent Application Publication
(10) Pub. No.: US 2009/0164728 A1
(43) Pub. Date: Jun. 25, 2009

(54) SEMICONDUCTOR MEMORY DEVICE AND SYSTEM USING SEMICONDUCTOR MEMORY DEVICE

(75) Inventor: Kazuhiko KAJIGAYA, Tokyo (JP)

Correspondence Address: MCDERMOTT WILL & EMERY LLP, 600 13TH STREET, N.W., WASHINGTON, DC, 20005-3096, US

(73) Assignee: ELPIDA MEMORY, INC.

(21) Appl. No.: 12/337,186

(22) Filed: Dec. 17, 2008

(30) Foreign Application Priority Data
Dec. 20, 2007 (JP) P2007-328597

(51) Int. Cl. G06F 12/02; G06F 12/00

(52) U.S. Cl. 711/118; 711/200; 711/E12.001; 711/E12.002

(57) ABSTRACT

A semiconductor memory device includes a data storage region which includes a plurality of unit data regions storing data, an information storage region which includes a plurality of unit information regions each storing information related to the data stored in associated one of the unit data regions, and an address generation circuit which generates an address designating one of the unit data regions and one of the unit information regions associated with each other.

### BACKGROUND OF THE INVENTION

1. Field of the Invention

The present invention relates to a semiconductor memory device used for a shared memory which is accessed by a plurality of processors such as a multi-core processor having a cache memory and the like, and by a direct memory access (DMA) controller, in a semiconductor integrated circuit, and a system using the semiconductor memory device.

Priority is claimed on Japanese Patent Application No. 2007-328597, filed Dec. 20, 2007, the content of which is incorporated herein by reference.

2. Description of Related Art

In a general single core processor, one processor core, which interrupts a command and executes an operation and the like, is incorporated in the package.

On the other hand, a plurality of the processor cores is incorporated in a multi-core processor, and hence, the multi-core processor assumes a state in which a plurality of micro processors is installed, which is the opposite of the above single core processor.

A system, which incorporates the shared memory accessed by a plurality of the processor cores of the above multi-core processor having the cache memory and the like, and by the DMA controller, requires maintenance of cache coherency in each memory hierarchy.

In a directory-based cache system, a technology that maintains the cache coherency has already been disclosed (for example, refer to Japanese Unexamined Patent Application, First Publication, No. 2004-326734).

For example, FIG. 19A shows a main memory system 60 that uses the directory-based cache coherency, and FIGS. 19B and 19C show operation sequences of the main memory system 60 shown in FIG. 19A, shown in the prior art JP 2004-326734 A.

A data bus 62 shown in FIG. 19A includes a data bit having a bit width of 128 bits and an information bit (error check and correct, and directory tag bit) having a bit width of 16 bits.

In order to write information, which includes an error check and correct (ECC) and a directory tag bit, in dual in-line memory modules (DIMM) 68, 70, 72 and 74, the main memory system 60 shown in FIG. 19A is assumed to have an exclusive dynamic random access memory (DRAM).

For this reason, there is a problem in that an overhead of the main memory system 60 shown in FIG. 19A is large when compared to a system without ECC.

Moreover, since the main memory system 60 shown in FIG. 19A executes a memory access only for updating the directory tag bit using about 1 to 4 cycles whenever the data bit is rewritten, there is another problem in that the band width of the main memory system 60 is reduced.

On the other hand, FIG. 20A shows the modified main memory system 120 that modifies the configuration of the memory system 60 shown in FIG. 19A, and FIG. 20B shows the operation sequence of the modified main memory system shown in FIG. 20A, shown in the prior art JP 2004-326734 A.

The main memory system 120 shown in FIG. 20A has a data bus 122 which includes a data bit having a bit width of 128 bits, and four information bits each corresponding to the DIMM 68, 70, 72 and 74, each having a bit width of 16 bits.

According to the configuration of the main memory system 120 shown in FIG. 20A, when the directory tag bit is updated for the different DIMM, since the reading from the data bit and writing in the directory tag bit are simultaneously performed, the reduction of the band width of the main memory system 120 can be prevented.

However, a scheme shown in FIG. 20A requires an information bit with a bit width of four times wider than the case shown in FIG. 19A. An exclusive DRAM is further required to add to the ECC and the directory tag bit. Therefore, there remains a problem in that the overhead is large for the system without ECC.

On the other hand, there is a scheme that the cache coherency is maintained by software, without having and using hardware to maintain the cache coherency.

In this scheme, however, the load of creating software increases. In particular, the development period is further extended so as to increase the production cost, even when the system is shared by a number of processors.

### SUMMARY

The present invention seeks to solve one or more of the above problems, or to improve those problems at least in part.

In one embodiment, there is provided a semiconductor memory device that includes a data storage region which includes a plurality of unit data regions storing data, an information storage region which includes a plurality of unit information regions each storing information related to the data stored in associated one of the unit data regions, and an address generation circuit which generates an address designating one of the unit data regions and one of the unit information region associated with each other.

In another embodiment, there is provided a data process system that includes a memory cell array which includes a data storage region, an information storage region, and an address generation circuit, wherein the data storage region includes a plurality of unit data regions storing data, the information storage region includes a plurality of unit information regions each storing information related to the data stored in associated one of the unit data regions, and the address generation circuit generates an address designating one of the unit data regions and one of the unit information regions associated with each other, and a multi-core processor which includes a plurality of core central processor units (CPUs), wherein a cache line size of the core CPU is equal to that of the unit data region in the data storage region.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram that shows an example of a configuration of a semiconductor memory device according to a first embodiment of the present invention;

FIG. 2 is a block diagram that shows a configuration of a bank shown in FIG. 1;

FIG. 3 is a block diagram that shows a configuration of a data storage region and an information storage region in the bank shown in FIG. 1 in the case of a cache line size having 4 bytes;

FIG. 4 is a block diagram that shows the configuration of the data storage region and the information storage region in the bank shown in FIG. 1 in the case of the cache line size having 32 bytes;

FIG. 5 is a block diagram that shows the configuration of the data storage region and the information storage region in the bank shown in FIG. 1 in the case of the cache line size having 256 bytes;

FIG. 6A is a circuit diagram that shows a configuration example of an information storage region address generation circuit shown in FIG. 1;

FIG. 6B is a table that shows initial values input to the information storage region address generation circuit shown in FIG. 6A, where VDD is the power supply voltage and VSS is the ground voltage;

FIG. 7A is a schematic diagram that shows generation of an address of the information storage region in the case of a data bus DQ with 4 bits and the cache line size with 4 bytes;

FIG. 7B is a schematic diagram that shows generation of the address of the information storage region in the case of the data bus DQ with 4 bits and the cache line size with 32 bytes;

FIG. 7C is a schematic diagram that shows generation of the address of the information storage region in the case of the data bus DQ with 4 bits and the cache line size with 256 bytes;

FIG. 8 is a timing chart that shows input and output waveforms of the data bus DQ and an information bus IQ in the case of the data bus DQ having a 4-bit configuration;

FIG. 9A is a schematic diagram that shows generation of the address of the information storage region in the case of the data bus DQ with 8 bits and a cache line size of 4 bytes;

FIG. 9B is a schematic diagram that shows generation of the address of the information storage region in the case of the data bus DQ with 8 bits and a cache line size of 32 bytes;

FIG. 9C is a schematic diagram that shows generation of the address of the information storage region in the case of the data bus DQ with 8 bits and a cache line size of 256 bytes;

FIG. 10 is a timing chart that shows the input and output waveforms of the data bus DQ and the information bus IQ in the case of the data bus DQ having an 8-bit configuration;

FIG. 11A is a schematic diagram that shows generation of the address of the information storage region in the case of the data bus DQ with 16 bits and a cache line size of 4 bytes;

FIG. 11B is a schematic diagram that shows generation of the address of the information storage region in the case of the data bus DQ with 16 bits and a cache line size of 32 bytes;

FIG. 11C is a schematic diagram that shows generation of the address of the information storage region in the case of the data bus DQ with 16 bits and a cache line size of 256 bytes;

FIG. 12 is a timing chart that shows the input and output waveforms of the data bus DQ and the information bus IQ in the case of the data bus DQ having a 16-bit configuration;

FIG. 13A is a schematic diagram that shows generation of the address of the information storage region in the case of the data bus DQ with 32 bits and a cache line size of 4 bytes;

FIG. 13B is a schematic diagram that shows generation of the address of the information storage region in the case of the data bus DQ with 32 bits and a cache line size of 32 bytes;

FIG. 13C is a schematic diagram that shows generation of the address of the information storage region in the case of the data bus DQ with 32 bits and a cache line size of 256 bytes;

FIG. 14 is a timing chart that shows the input and output waveforms of the data bus DQ and the information bus IQ in the case of the data bus DQ having a 32-bit configuration;

FIG. 15 is a table that shows a configuration of writing in and reading from the data storage region and the information storage region;

FIG. 16 is a timing chart that shows the input and output waveforms of the data bus DQ and the information bus IQ;

FIG. 17 is a block diagram that shows a computer system, which includes a multi-core processor and the semiconductor memory device of the first embodiment, according to a second embodiment of the present invention;

FIG. 18 is a block diagram that shows a computer system, which includes the multi-core processor and the semiconductor memory device of the first embodiment, according to a third embodiment of the present invention;

FIG. 19A is a schematic diagram that shows a configuration of a main memory system using a directory-based cache coherency in the prior art;

FIG. 19B is a schematic diagram that shows an operation sequence of the main memory system shown in FIG. 19A;

FIG. 19C is a schematic diagram that shows the operation sequence of the main memory system shown in FIG. 19A;

FIG. 20A is a schematic diagram that shows the configuration of the main memory system using the directory-based cache coherency in the prior art; and

FIG. 20B is a schematic diagram that shows the operation sequence of the main memory system shown in FIG. 20A.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated here for explanatory purposes.

### First Embodiment

A semiconductor memory device according to embodiments of the present invention will be described hereinbelow with reference to the drawings.

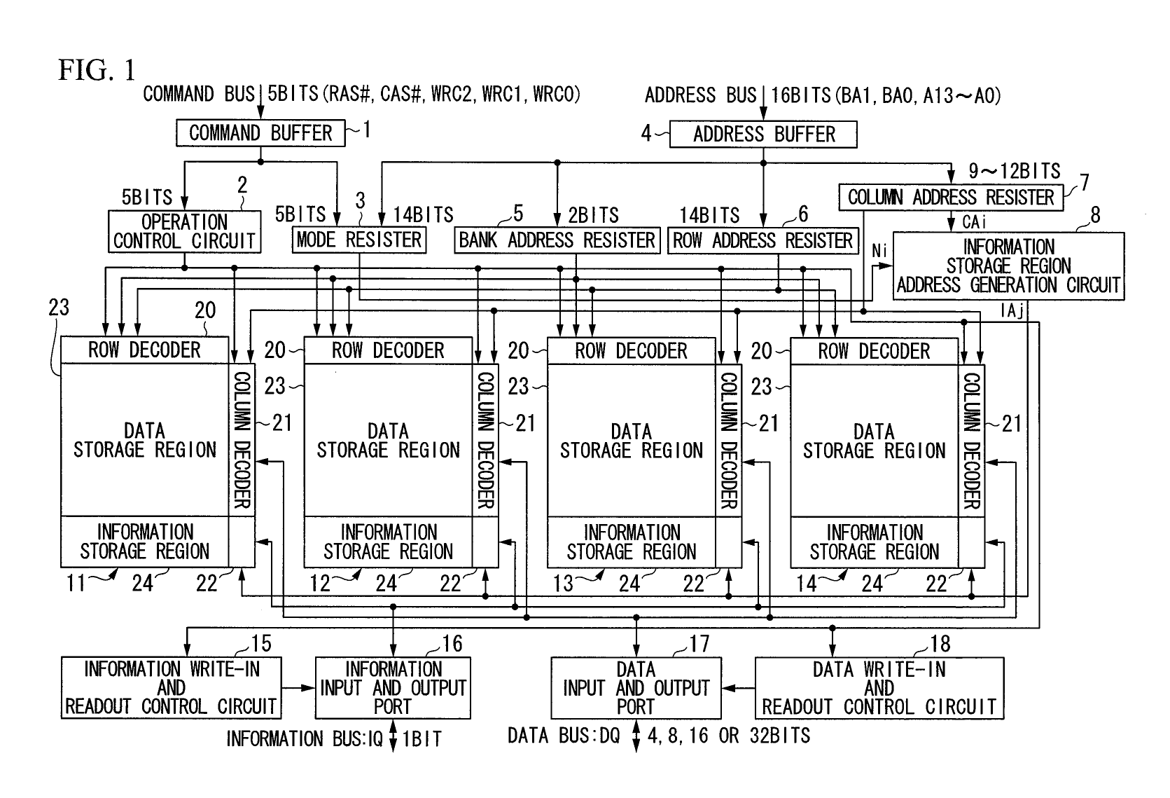

FIG. 1 shows an example of a configuration of a semiconductor memory device according to a first embodiment. The semiconductor memory device is formed on a semiconductor substrate, such as silicon and the like, and applied to a system that operates a memory management with the cache coherency.

In the present embodiment, although the semiconductor memory device is described hereinbelow by using a dynamic random access memory (DRAM) with the storage capacity of 1 Gbit as an example, the storage capacity is not limited by this example. Moreover, the semiconductor memory device can be applied to any other rewritable memory than DRAM, such as a static random access memory (SRAM).

As shown in FIG. 1, the semiconductor memory device includes a command buffer 1, an operation control circuit 2, a mode resister 3, an address buffer 4, a bank address resister 5, a row address resister 6, a column address resister 7, an information storage region address generation circuit 8, banks 11 to 14, an information write-in and readout control circuit 15, an information input and output port 16, a data input and output port 17, and a data write-in and readout control circuit 18.

The 1 Gbit DRAM of the present embodiment is made of four banks 11, 12, 13 and 14 that include a data storage region with 256 Mbits, an information storage region of 8 Mbits for storing information of data in the data storage region.

Each bank includes a row decoder 20, a column decoder 21, an information storage region column decoder 22, a data storage region 23, and an information storage region 24.

Each bank includes the above-mentioned data storage region 23 and information storage region 24 as a memory cell array which is made of a plurality of memory cells placed at intersections of a plurality of bit lines and a plurality of word lines.

The command buffer 1 latches a command signal which is input from outside and has 5 bits (RAS#, CAS#, WRC2, WRC1 and WAC0), and outputs the latched command signal to the operation control circuit 2 and the mode resister 3.

The operation control circuit 2 controls the information write-in and readout control circuit 15 and the data write-in and readout control circuit 18 for writing and reading data via the information input and output port 16 and the data input and output port 17, in response to the input command signal.

The mode resister 3 sets a byte number of a unit data region of the data storage region 23, which will be described hereinbelow, and an operation mode of the semiconductor memory device, in response to a set value obtained by a specific data combination of the command signals which is input from outside and is control signal, and by a bit pattern which is input in synchronization with the command signal.

The address buffer 4 latches an address signal which is input from outside and has 16 bits (BA1, BA0, and A13-A0), and outputs the latched address signal to the mode resister 3, the bank address resister 5, the row address resister 6, and the column resister 7.

The bank address resister 5 selects one among the banks 11 to 14 in accordance with the address control signals BA0 and BA1.

The row address resister 6 outputs the address signal of 14 bits (A13-A0) to the row decoder 20 of each bank.

Some of the bits, from 9 bits to 12 bits, of the address signal (A13-A0) are assigned to a column address CAi in accordance with the bit width, and input to the column address resister 7. The column address resister 7 outputs the input column address CAi to the column decoder 21 of each bank, and outputs an initial address value, which is input to the column address resister 7, to the information storage region address generation circuit 8. Moreover, the column address resister 7 executes an increment of the input column address CAi in synchronization with the data input and output, when burst input and output are operated.

The information storage region address generation circuit 8, as will be set forth hereinafter, outputs an information storage region column address IAj to the information storage region column decoder 22 by virtue of the set value of the mode resister 3 and the column address CAi output from the column address resister 7. The column address CAi, to which the initial address value without the increment inputs, is stored in the information storage region address generation circuit 8.

The data storage region 23 has the storage capacity of 256 Mbits as described above, and the bit width corresponding to a data bus DQ can be set to 4, 8, 16, or 32 bits. For example, one configuration among those bit widths is selected by converting a wiring layer or bonding, at the production stage.

The information storage region 24 has the storage capacity of 8 Mbits, and the bit width corresponding to an information bus IQ keeps to be set to a 1 bit.

The data storage region 23 and the information storage region 24 include the information input and output port 16 and the data input and output port 17 which are independent from each other.

The data input and output port 17 inputs and outputs data of the data storage region 23, via the data bus DQ, controlled by the data write-in and readout control circuit 18. The information input and output port 16 inputs and outputs data of the information storage region 24, via the information bus IQ, controlled by the information write-in and readout control circuit 15.

The bit width of the data bus DQ, as described above, corresponds to the bit width of the data storage region 23, and is set to one bit width among the 4, 8, 16, or 32 bits at the production stage.

The bit width of the information bus IQ corresponds to the bit width of the information storage region 24, and is set to 1 bit at the production stage.

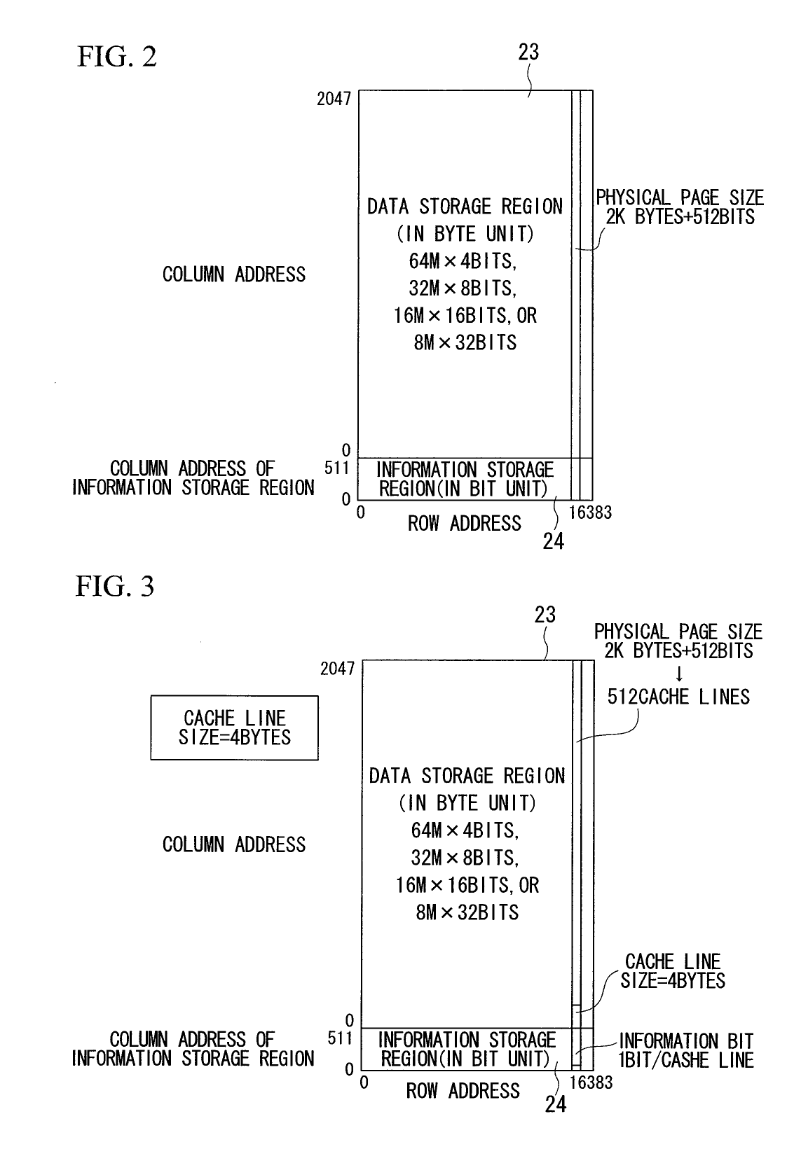

Subsequently, a configuration of the memory region corresponding to one bank will be set forth hereinbelow with reference to FIG. 2. FIG. 2 shows the configuration of the bank shown in FIG. 1, for example, the bank 11 in detail.

As is described above, the data storage region 23 has a storage capacity of 256 Mbits, while the information storage region 24 has a storage capacity of 8 Mbits.

In this case, a word line, which is selected by the row address, has 16384 lines, and a bit line, which is selected by the column address, has 16384 lines (where 2 kbytes=2048 bits×8).

That is, the row decoder 20 selects one physical page among 16384 physical pages assigned from an address 0 to an address 16383 by the row address with 14 bits.

The size of one physical page, which is selected by one of the word lines, is a summation of 2 kbytes of the data storage region 23 (where 1 byte=8 bits) and 512 bytes of the information storage region 24.

As shown in FIG. 2, the data storage region and the information storage region, which belong to the same physical page, are simultaneously selected by the same row address.

The column address of the data storage region 23 has 2048 bytes (2 kbytes) which are assigned from an address 0 to an address 2047 (where the addresses are shown in byte), and is accessed to have the bit width of 4, 8, 16 or 32 bits, in accordance with the number of column addresses corresponding to the bit configuration (bit width). Therefore, the columns address has 12 bits in the case of a bit width of 4 bits, the columns address has 11 bits in the case of a bit width of 8 bits, the columns address has 10 bits in the case of a bit width of 16 bits, and the columns address has 9 bits in the case of a bit width of 32 bits.

On the other hand, the column address of the information storage region 24 has 512 bits which are assigned from an address 0 to an address 511 (where the addresses are shown in bit), and is accessed with the bit width keeping a 1 bit.

Subsequently, FIG. 3 to FIG. 5 show configurations of the memory region in the physical page shown in FIG. 2, when the memory region is divided in order to adapt to a cache line size of the core central processor unit (CPU).

The cache line size is generally set to between 32 bytes to 256 bytes.

In the case of a main memory system with a mass storage capacity, a module style, which has a plurality of DRAMs, is generally provided. In this case, a basic configuration has eight pieces of DRAM so that the minimum size of each cache line has 4 bytes.

On the other hand, there is a case that a main memory system has one DRAM in a small scale system. In this case, the maximum size of the cache line has 256 bytes. Therefore, the cache line size is assumed to between 4 bytes to 256 bytes, as described hereinafter.

FIG. 3 shows the configuration of the memory region when the cache line size has 4 bytes. The data storage region 23 is divided into unit data regions with 4 bytes. One physical page includes 512 pieces of the unit data regions. The information storage region 24 is assigned to each unit data region. In this case, since the information storage region 24 is divided into unit information regions with 1 bit, there are 512 pieces of the unit information regions in the information storage region 24, and each unit data region corresponds to each unit information region on a one-to-one basis. Accordingly, each 1 bit of the information storage region 24 having 512 bits is assigned to the unit data region.

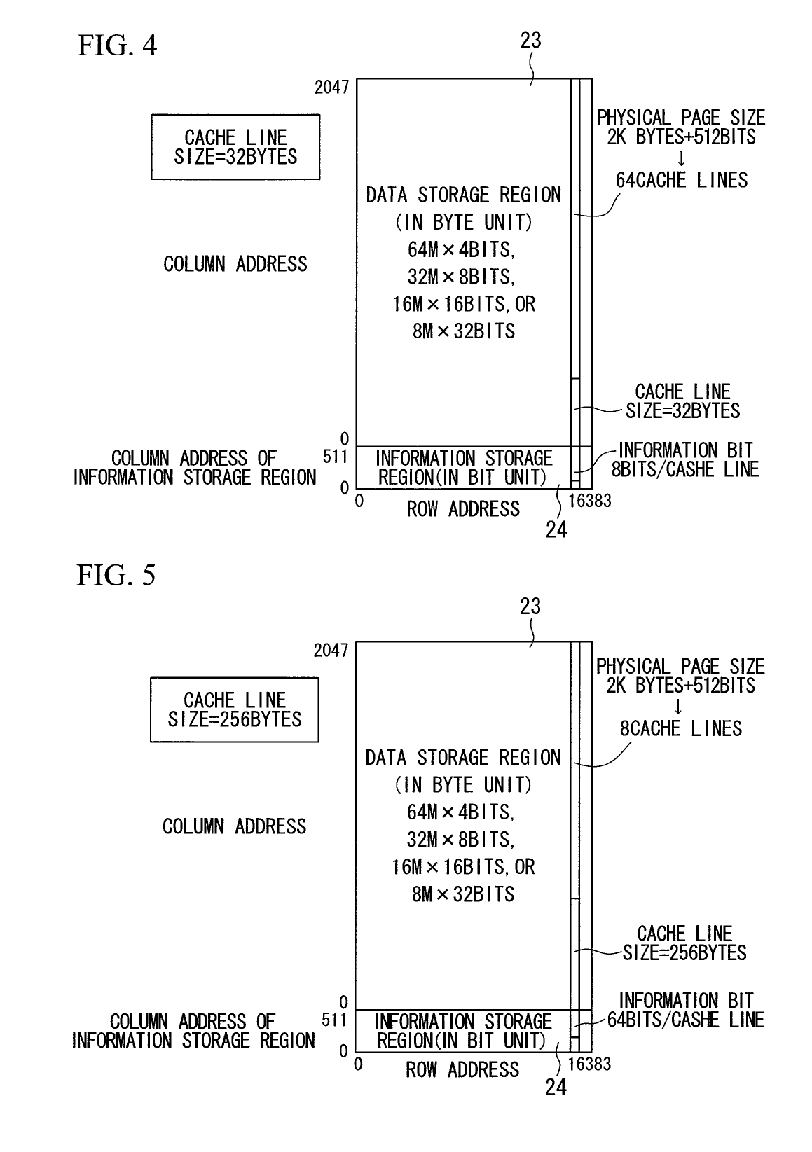

FIG. 4 shows the configuration of the memory region when the cache line size has 32 bytes. The data storage region 23 is divided into unit data regions with 32 bytes. One physical page includes 64 pieces of the unit data regions. The information storage region 24 is assigned to each unit data region. In this case, since the information storage region 24 is divided into unit information regions with 8 bits, there are 64 pieces of the unit information regions in the information storage region 24, and each unit data region corresponds to each unit information region on a one-to-one basis. Accordingly, each 8 bits of the information storage region 24 having 512 bits is assigned to the unit data region.

FIG. 5 shows the configuration of the memory region when the cache line size has 256 bytes. The data storage region 23 is divided into unit data regions with 256 bytes. One physical page includes 8 pieces of the unit data regions. The information storage region 24 is assigned to each unit data region. In this case, since the information storage region 24 is divided into unit information regions with 64 bits, there are 8 pieces of the unit information regions in the information storage region 24, and each unit data region corresponds to each unit information region on a one-to-one basis. Accordingly, each 64 bits of the information storage region 24 having 512 bits is assigned to the unit data region.

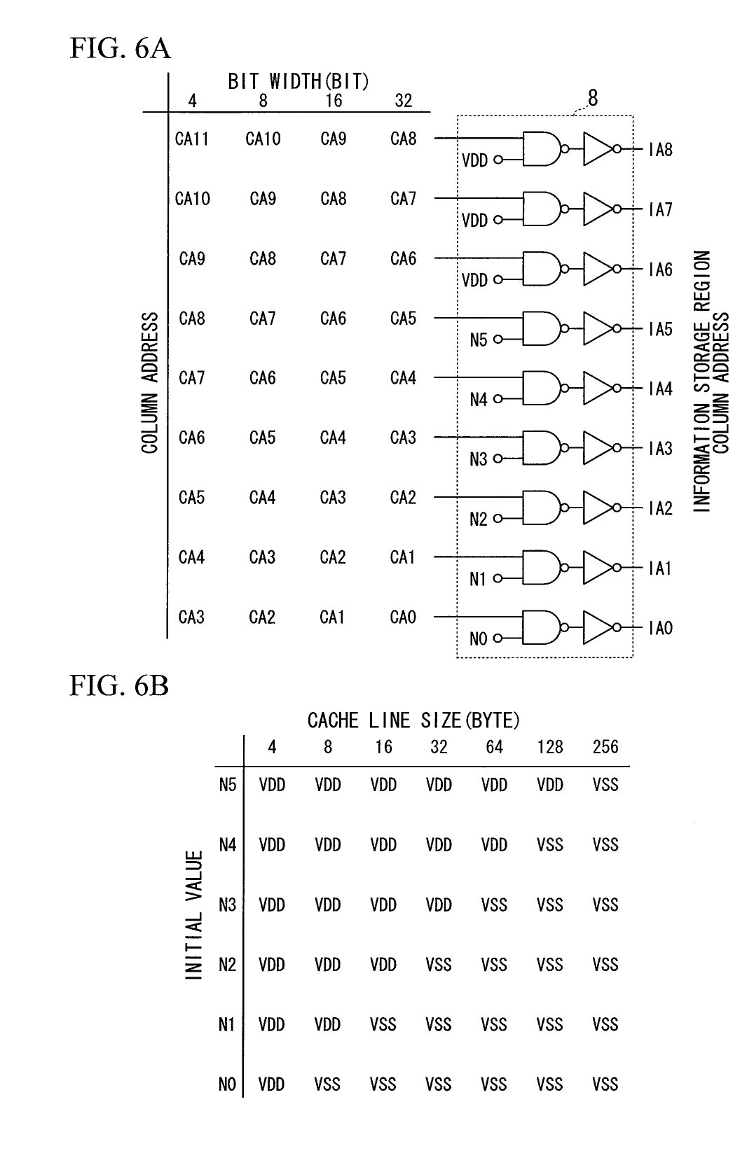

FIG. 6A shows an example of a configuration of the information storage region address generation circuit 8 shown in FIG. 1. The information storage region column address IAj with 9 bits is generated by virtue of the column address CAi, in accordance with column addresses of the information storage region from an address 0 to an address 511. The information storage region address generation circuit 8 includes NAND and NOT elements connected in serial in each bit. The column address CAi inputs to one input terminal of the NAND element, and a power supply voltage (VDD) and an initial value Ni input to the other input terminal of the NAND element, as shown in FIG. 6A.

FIG. 6B shows the content of the initial values N0 to N5 that input to the information storage region address generation circuit 8 shown in FIG. 6A. When a division number, by which the data storage region 23 is divided into the unit data region with the bit width corresponding to the cache line size, agrees with a division number, by which the information storage region 24 is divided into the unit information region, and the unit data region is accessed, the content of the initial values N0 to N5 is set to the power supply voltage (VDD) or a ground voltage (VSS) as shown in FIG. 6B in accordance with the cache line size, in order to select the unit information region corresponding to the unit data region, that is, in order to access the least significant address of the information storage region 24.

Although it is not illustrated in FIG. 6, the information storage region address generation circuit 8 executes the increment of the information storage region column address from the least significant address, in synchronization with the increment of the address of the column address resister 7.

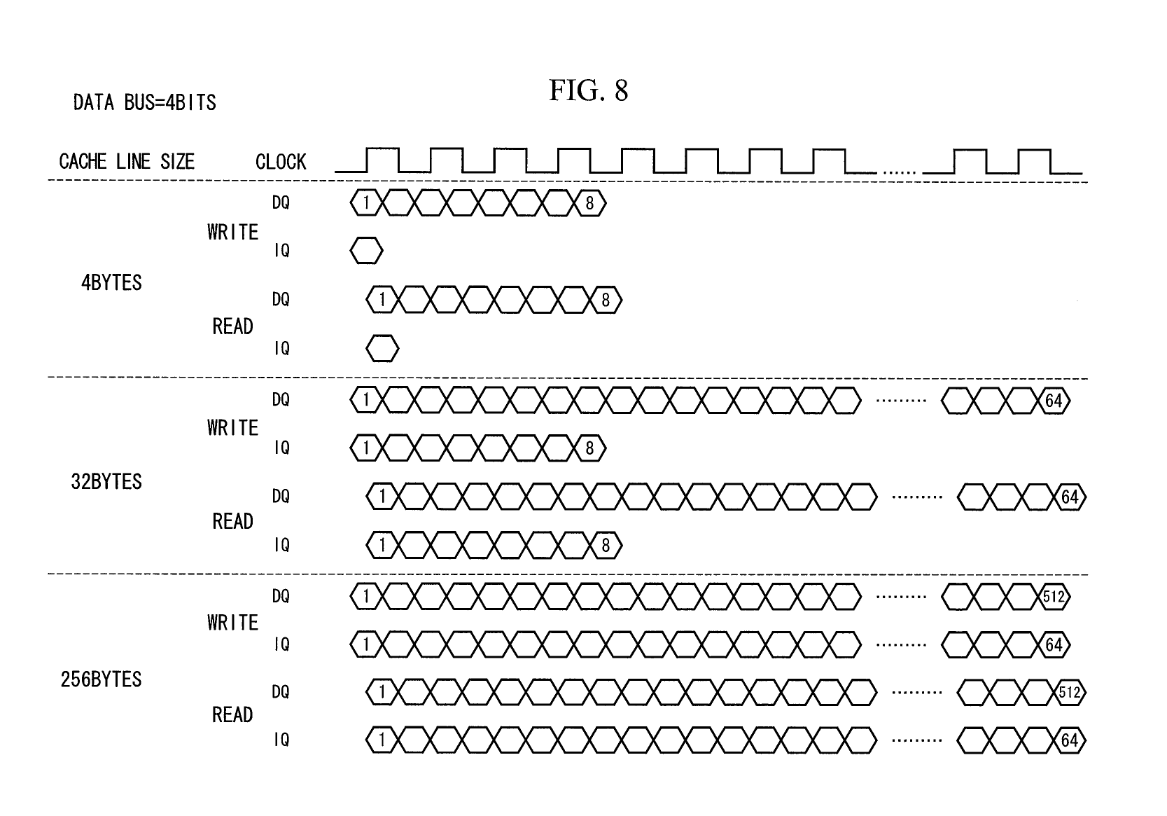

Furthermore, the information write-in and readout control circuit 15 outputs the data of the information storage region 24, which corresponds to the above unit data region, to the information input and output port 16 by 1 bit for every increment, in synchronization with the time when the data input and output port 17 of the data write-in and readout control circuit 18 outputs data. This synchronization operation is made by synchronizing with an operation clock which is output from the operation control circuit 2, and the synchronized time is indicated by a clock shown hereinafter in FIGS. 8, 10, 12 and 14.

Even though any addresses in the cache line are accessed, the least significant address of the information storage region 24 is firstly accessed by virtue of the information storage region address generation circuit 8 described above, and hence, there is an advantageous effect in that it becomes easy to set the storage region for necessary information.

Furthermore, as described above, the information storage region address generation circuit 8 executes the increment of the column address from the least significant address in sequence, so as to operate burst output of data of the unit information region.

Setting information of the cache line size (the initial value Ni) is provided by or via the mode resister 3. For example, the bit width of the cache line can be arbitrary set to one of 4 bytes, 32 bytes and 256 bytes by an external control signal, in order to adapt to the cache line size of the core CPU.

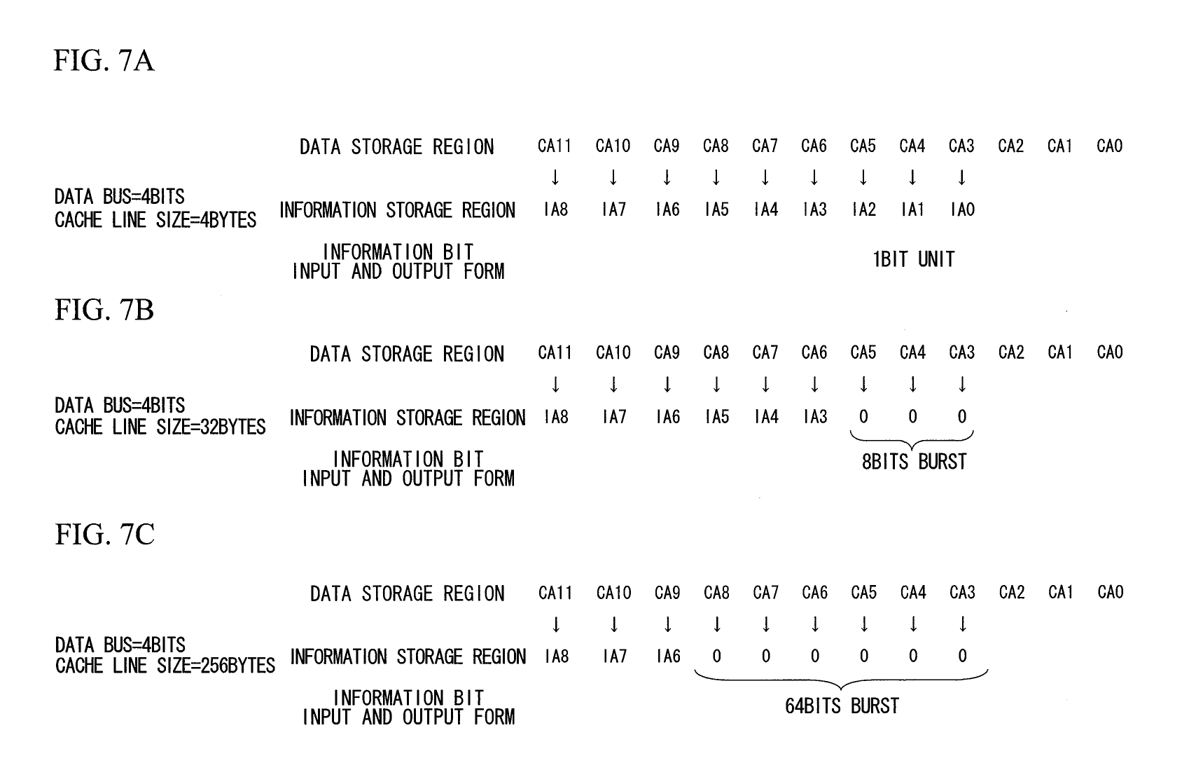

FIG. 7A through FIG. 14 show configurations of the information storage region column address IAj generated by the information storage region address generation circuit 8 in the case of a bit width of the cache line size having 4 bytes, 32 bytes, and 256 bytes for the respective memory configuration of 4 bits, 8 bits, 16 bits and 32 bits.

FIG. 7A to FIG. 7C show the configurations of the information storage region column address IAj generated by the information storage region address generation circuit 8 shown in FIG. 6A, in the case of the data bus DQ having 4 bits. As shown in FIGS. 7A to 7C, the column address CAi has 12 bits (CA0 to CA11), and is converted into the information storage region column address IAj at the information storage region address generation circuit 8 shown in FIG. 6A.

In the case of the cache line size having 4 bytes, the unit information region of the information storage region 24 is assigned to each unit data region of the data storage region 23, as a configuration with a 1-bit width (refer to FIG. 7A).

In the case of the cache line size having 32 bytes, the unit information region of the information storage region 24 is assigned to each unit data region of the data storage region 23, as a configuration with an 8-bit width. Since the information bus IQ has a 1-bit width, the other 7 bits are accessed by the burst mode, as described above (refer to FIG. 7B).

In the case of the cache line size having 256 bytes, the unit information region of the information storage region 24 is assigned to each unit data region of the data storage region 23, as a configuration with a 64-bit width. Since the information bus IQ has a 1-bit width, the other 63 bits are accessed by the burst mode, as described above (refer to FIG. 7C).

FIG. 8 shows input and output waveforms of the data bus DQ and the information bus IQ when the data bus DQ has a 4-bit width as shown in FIGS. 7A to 7C. An example of FIG. 8 shows a so-called double data rate (DDR) mode in which data is input and output in synchronization with pull-up and pull-down of a clock signal. Since the data bus DQ has a 4-bit width, access to one cache line is completed by the 8-bit burst access when the cache line size has 4 bytes. At this time, data with a 1-bit width is input to and output from the information bus IQ in synchronization with the clock signal.

Then, access to one cache line is completed by the 64-bit burst access when the cache line size has 32 bytes. At this time, the 8-bit burst access is operated at the information bus IQ in synchronization with the clock signal.

Then, access to one cache line is completed by the 512-bit burst access when the cache line size has 256 bytes. At this time, the 64-bit burst access is operated at the information bus IQ in synchronization with the clock signal.

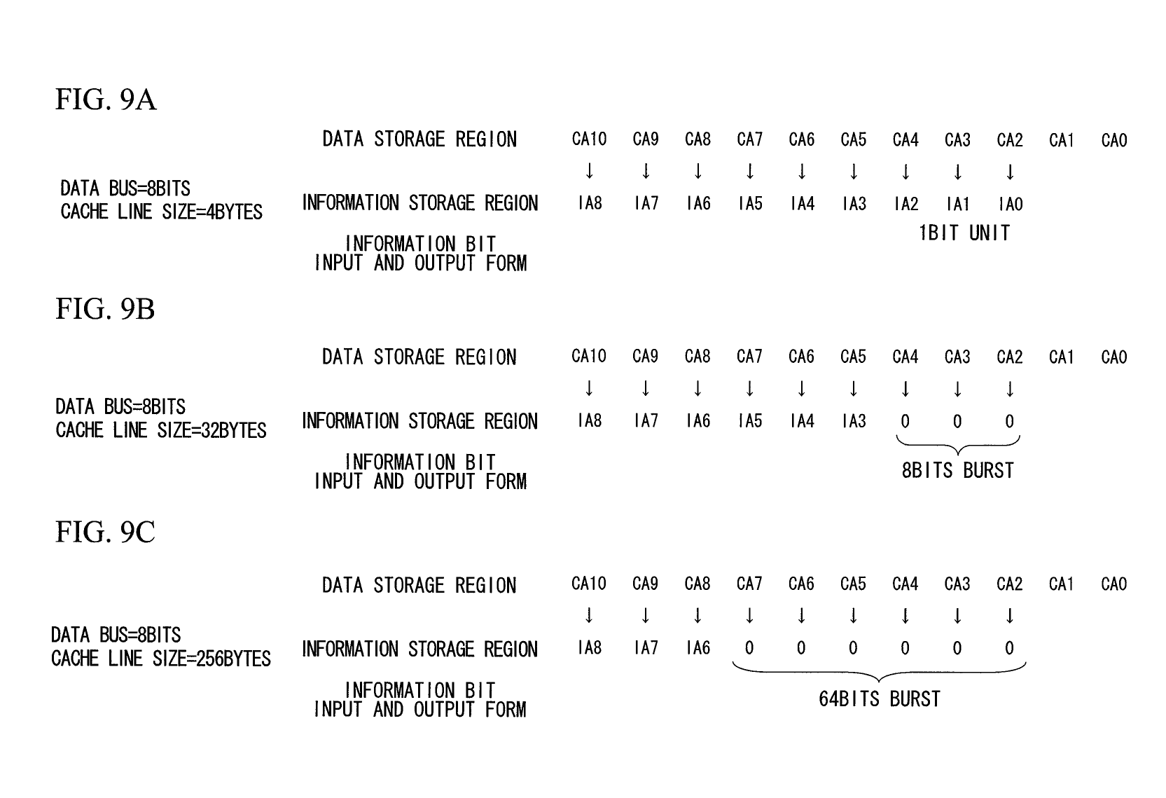

FIG. 9A to FIG. 9C show the configurations of the information storage region column address IAj generated by the information storage region address generation circuit 8 shown in FIG. 6A, in the case of the data bus DQ having 8 bits. As shown in FIGS. 9A to 9C, the column address CAi has 11 bits (CA0 to CA10), and is converted into the information storage region column address IAj at the information storage region address generation circuit 8 shown in FIG. 6A.

In the case of the cache line size having 4 bytes, the unit information region of the information storage region 24 is assigned to each unit data region of the data storage region 23, as a configuration with a 1-bit width (refer to FIG. 9A).

In the case of the cache line size having 32 bytes, the unit information region of the information storage region 24 is assigned to each unit data region of the data storage region 23, as a configuration with an 8-bit width. Since the information bus IQ has a 1-bit width, the other 7 bits are accessed by the burst mode, as described above (refer to FIG. 9B).

In the case of the cache line size having 256 bytes, the unit information region of the information storage region 24 is assigned to each unit data region of the data storage region 23, as a configuration with a 64-bit width. Since the information bus IQ has a 1-bit width, the other 63 bits is accessed by the burst mode, as described above (refer to FIG. 9C).

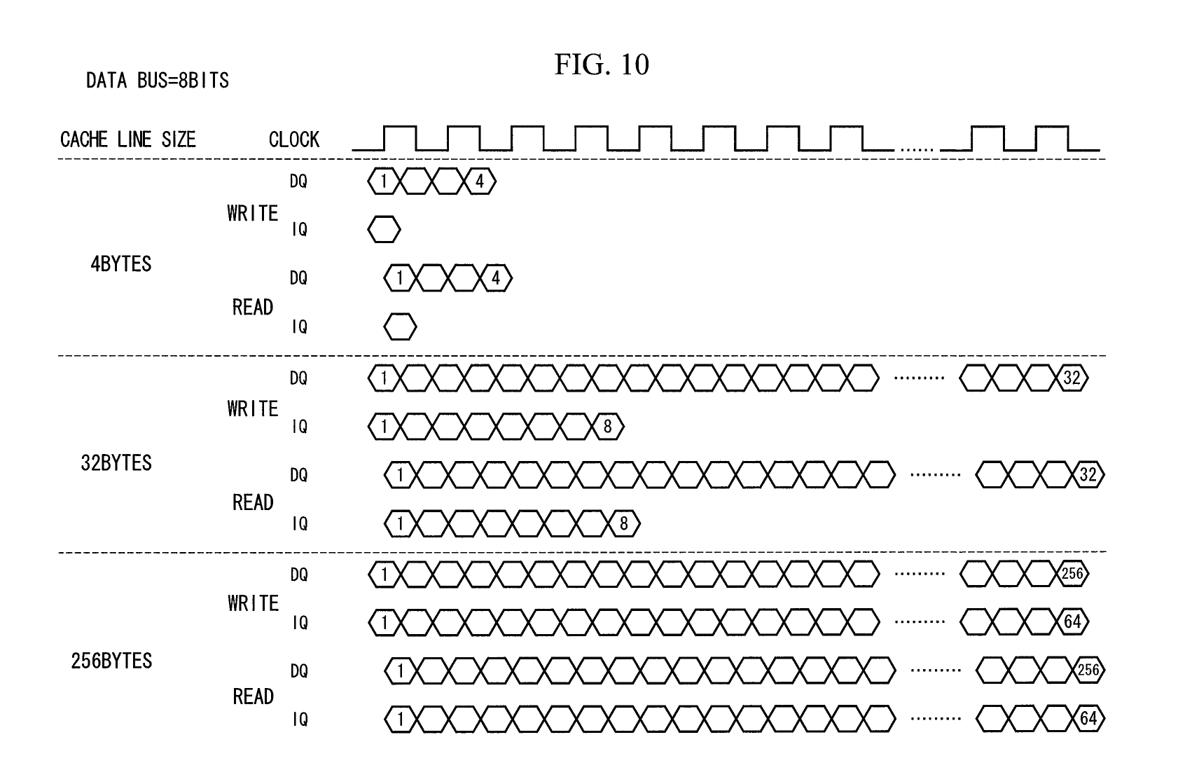

FIG. 10 shows the input and output waveforms of the data bus DQ and the information bus IQ when the data bus DQ has an 8-bit width as shown in FIGS. 9A to 9C. An example of FIG. 10 shows the DDR mode in which data is input and output in synchronization with pull-up and pull-down of the clock signal. Since the data bus DQ has an 8-bit width, access to one cache line is completed by the 4-bit burst access when the cache line size has 4 bytes. At this time, data with a 1-bit width is input to and output from the information bus IQ in synchronization with the clock signal.

Then, accessing to one cache line is completed by the 32-bit burst access when the cache line size has 32 bytes. At this time, the 8-bit burst access is operated at the information bus IQ in synchronization with the clock signal.

Then, accessing to one cache line is completed by the 256-bit burst access when the cache line size has 256 bytes. At this time, the 64-bit burst access is operated at the information bus IQ in synchronization with the clock signal.

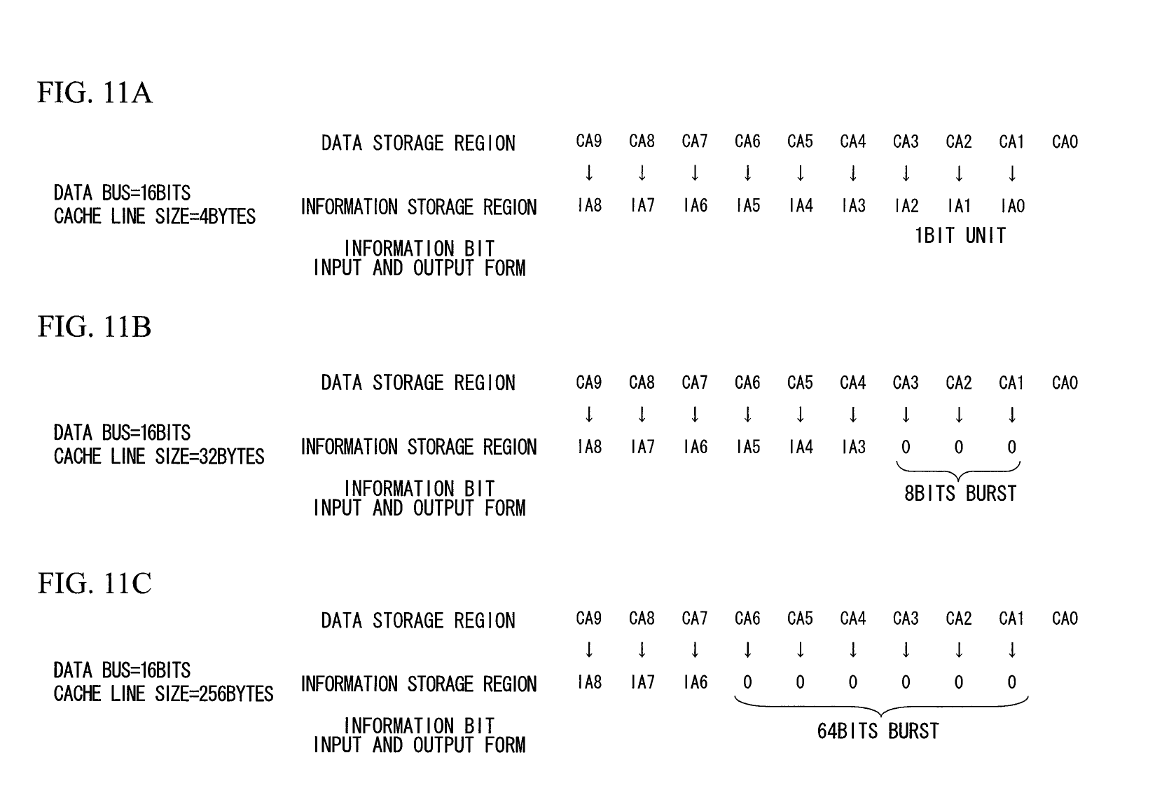

FIG. 11A to FIG. 11C show the configurations of the information storage region column address IAj generated by the information storage region address generation circuit 8 shown in FIG. 6A, in the case of the data bus DQ having 16 bits. As shown in FIGS. 11A to 11C, the column address CAi has 10 bits (CA0 to CA9), and is converted into the information storage region column address IAj at the information storage region address generation circuit 8 shown in FIG. 6A.

In the case of the cache line size having 4 bytes, the unit information region of the information storage region 24 is assigned to each unit data region of the data storage region 23, as a configuration with a 1-bit width (refer to FIG. 11A).

In the case of the cache line size having 32 bytes, the unit information region of the information storage region 24 is assigned to each unit data region of the data storage region 23, as a configuration with an 8-bit width. Since the information bus IQ has a 1-bit width, the other 7 bits are accessed by the burst mode, as described above (refer to FIG. 11B).

In the case of the cache line size having 256 bytes, the unit information region of the information storage region 24 is assigned to each unit data region of the data storage region 23, as a configuration with a 64-bit width. Since the information bus IQ has a 1-bit width, the other 63 bits are accessed by the burst mode, as described above (refer to FIG. 11C).

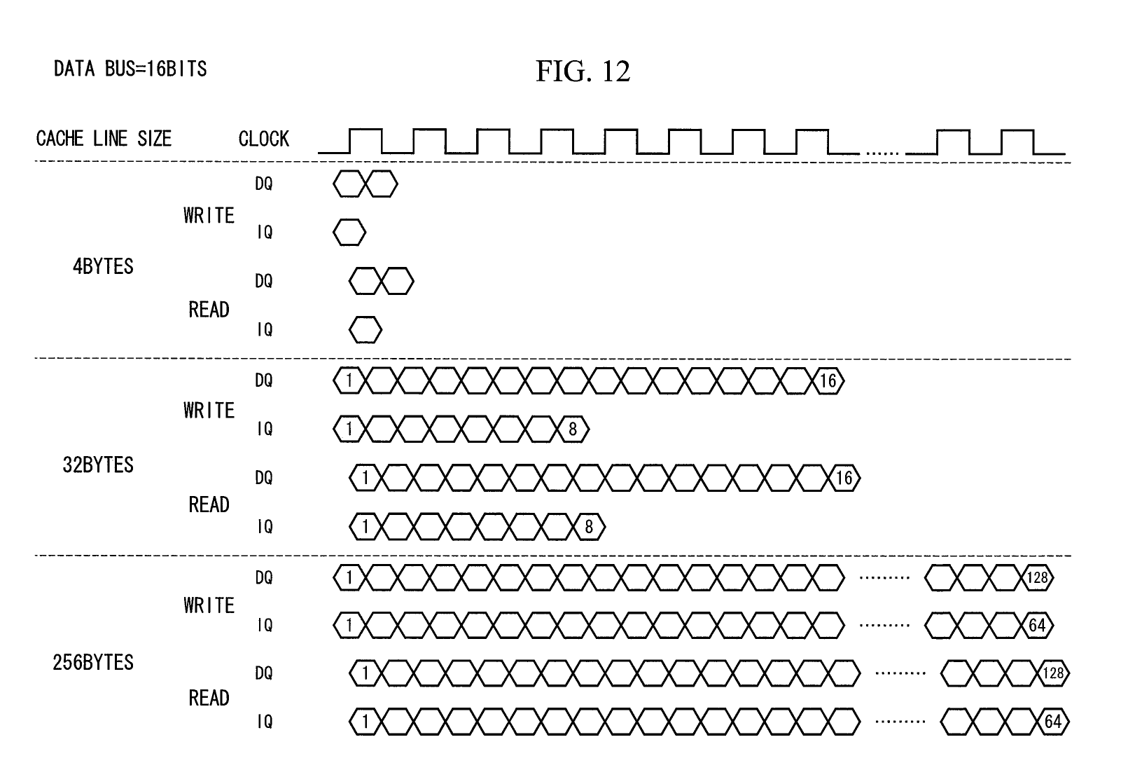

FIG. 12 shows the input and output waveforms of the data bus DQ and the information bus IQ when the data bus DQ has a 16-bit width as shown in FIGS. 11A to 11C. An example of FIG. 12 shows the DDR mode in which data is input and output in synchronization with pull-up and pull-down of the clock signal. Since the data bus DQ has a 16-bit width, access to one cache line is completed by the 2-bit burst access when the cache line size has 4 bytes. At this time, data with a -bit width is input to and output from the information bus IQ in synchronization with the clock signal.

Then, accessing to one cache line is completed by the 16-bit burst access when the cache line size has 32 bytes. At this time, the 8-bit burst access is operated at the information bus IQ in synchronization with the clock signal.

Then, access to one cache line is completed by the 128-bit burst access when the cache line size has 256 bytes. At this time, the 64-bit burst access is operated at the information bus IQ in synchronization with the clock signal.

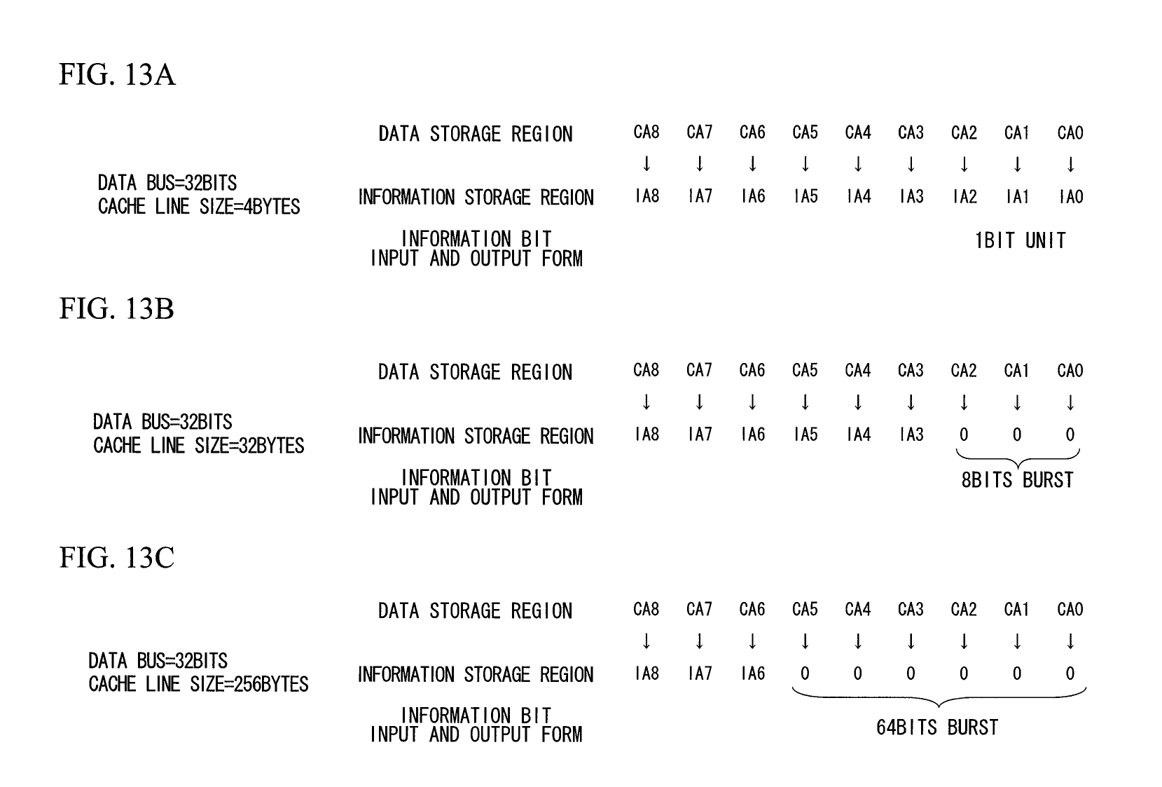

FIG. 13A to FIG. 13C show the configuration of the information storage region column address IAj generated by the information storage region address generation circuit 8 shown in FIG. 6A, in the case of the data bus DQ having 32 bits. As shown in FIGS. 13A to 13C, the column address CAi has 9 bits (CA0 to CA8), and is converted into the information storage region column address IAj at the information storage region address generation circuit 8 shown in FIG. 6A.

In the case of the cache line size having 4 bytes, the unit information region of the information storage region 24 is assigned to each unit data region of the data storage region 23, as a configuration with a 1-bit width (refer to FIG. 13A).

In the case of the cache line size having 32 bytes, the unit information region of the information storage region 24 is assigned to each unit data region of the data storage region 23, as a configuration with an 8-bit width. Since the information bus IQ has a 1-bit width, the other 7 bits are accessed by the burst mode, as described above (refer to FIG. 13B).

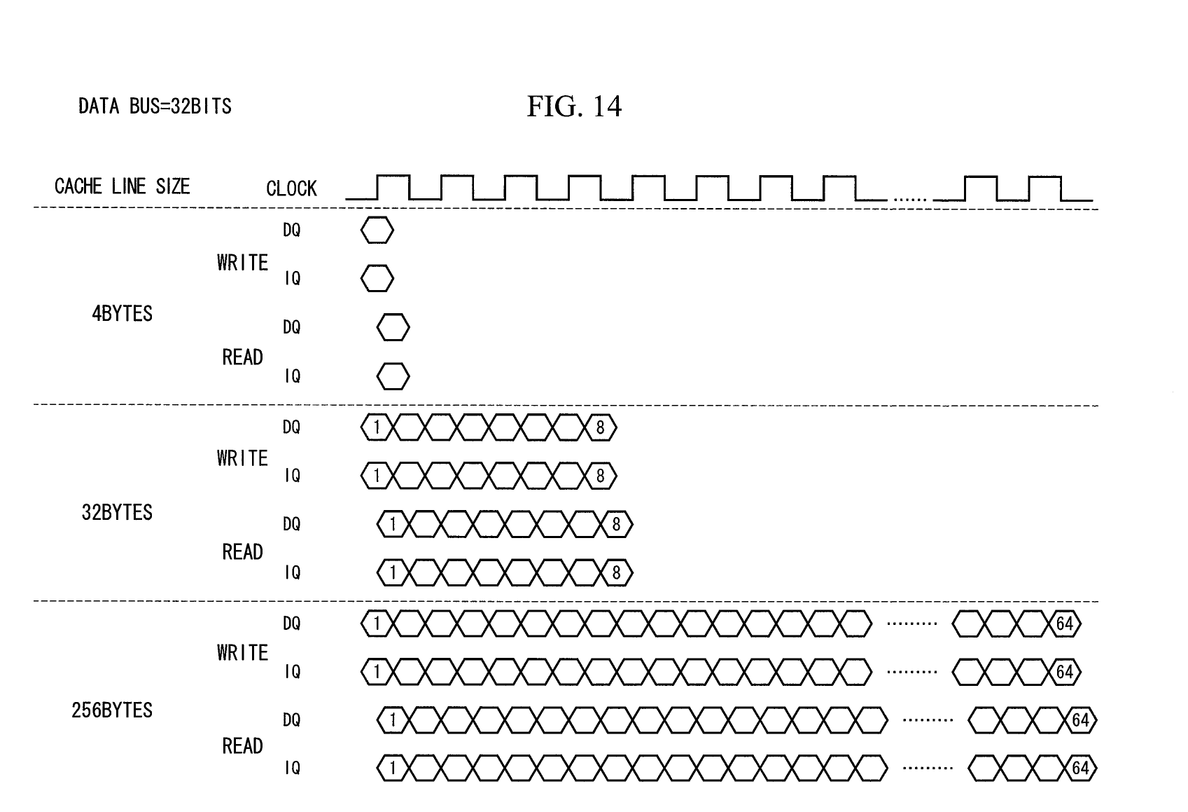

In the case of the cache line size having 256 bytes, the unit information region of the information storage region 24 is assigned to each unit data region of the data storage region 23, as a configuration with a 64-bit width. Since the information bus IQ has a 1-bit width, the other 63 bits are accessed by the burst mode, as described above (refer to FIG. 13C) FIG. 14 shows the input and output waveforms of the data bus DQ and the information bus IQ when the data bus DQ has a 32-bit width as shown in FIGS. 13A to 13C. An example of FIG. 14 shows the DDR mode in which data is input and output in synchronization with pull-up and pull-down of the clock signal. Since the data bus DQ has a 32-bit width, access to one cache line is completed by the 1-bit access when the cache line size has 4 bytes. At this time, data with a 1-bit width is input to and output from the information bus IQ in synchronization with the clock signal.

Then, access to one cache line is completed by the 8-bit burst access when the cache line size has 32 bytes. At this time, the 8-bit burst access is operated at the information bus IQ in synchronization with the clock signal.

Then, access to one cache line is completed by the 64-bit burst access when the cache line size has 256 bytes. At this time, the 64-bit burst access is operated at the information bus IQ in synchronization with the clock signal. When the data bus DQ has a 32-bit width, the burst length of the data bus DQ agrees with a length of the information bus IQ, as shown in FIGS. 14A to 14C.

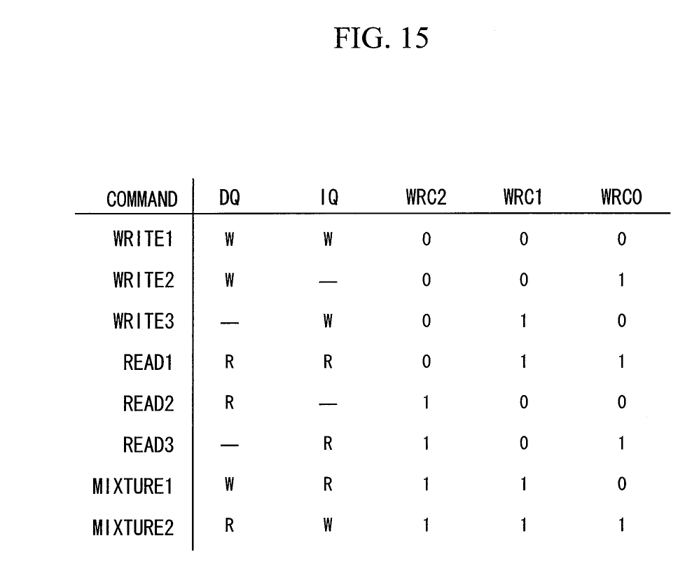

Subsequently, FIG. 15 shows a command table that controls writing in and reading from the data storage region 23 and the information storage region 24. Three command signals WRC0, WRC1 and WRC2 are employed to control the writing and reading in the present embodiment. By virtue of combination of these command signals, three write-in commands write 1, write 2 and write 3; three readout commands read 1, read 2 and read 3; and two mixture commands mixture 1 and mixture 2, which are directed to the data storage region 23 and the information storage region 24, can be set. Thereby, the data write-in and readout control circuit 18 and the information write-in and readout control circuit 15 control to write data in or read data from the data storage region 23, and control to write information data in or read information data from the information storage region 24, or whether or not to write in and read from the data.

The commands write 1 and read 1 are to simultaneously access the data storage region 23 (data bus DQ) and the information storage region 24 (information bus IQ) as the writing and reading processes.

The command write 2 is to access only the data storage region 23 in the writing process, and the command write 3 is to access only the information storage region 24 in the writing process.

The command read 2 is to access only the data storage region 23 in the reading process, and the command read 3 is to access only the information storage region 24 in the reading process.

On the other hand, the command mixture 1 is to write in the data storage region 23, and read from the information storage region 24. The command mixture 2 is to read from the data storage region 23, and write in the information storage region 24.

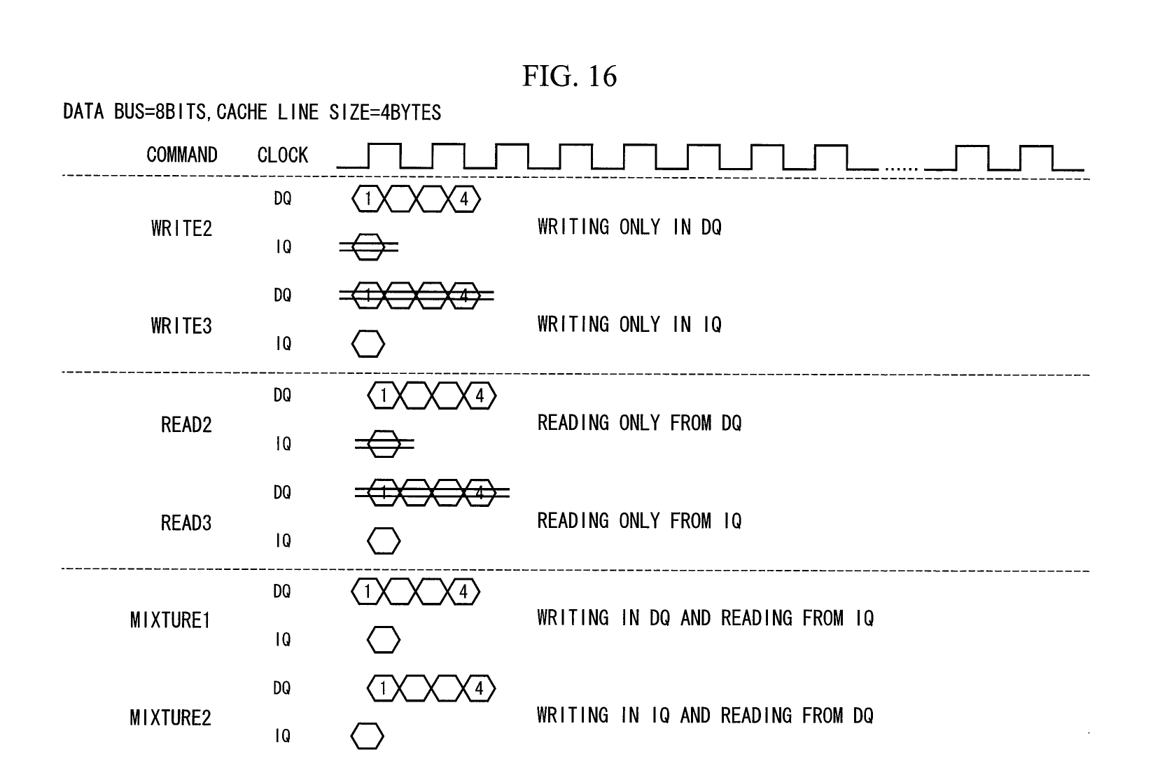

FIG. 16 shows the input and output waveforms of the data bus DQ and the information bus IQ except the commands write 1 and read 1 shown in FIG. 15, when the data bus DQ and the cache line size have an 8-bit width and 4 bytes. Since the waveforms are the same as the operation waveforms as described above, except that the waveforms which are erased by a double line show that the waveforms actually do not input and output, an explanation of the operation is omitted.

### Second Embodiment

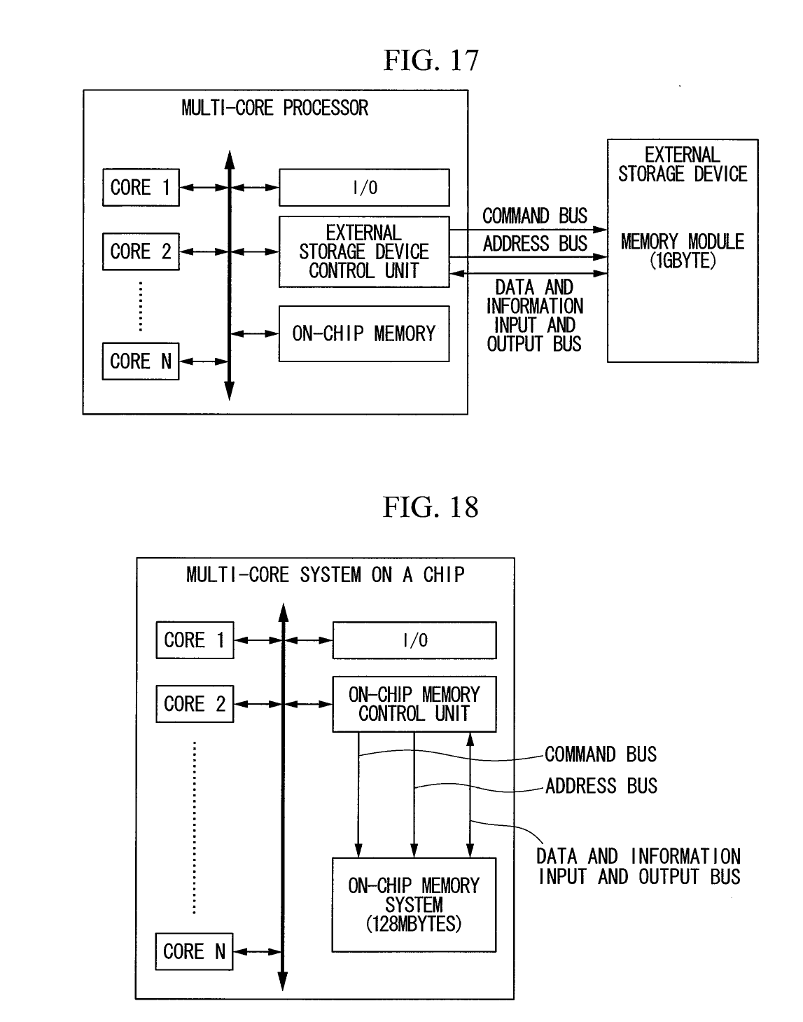

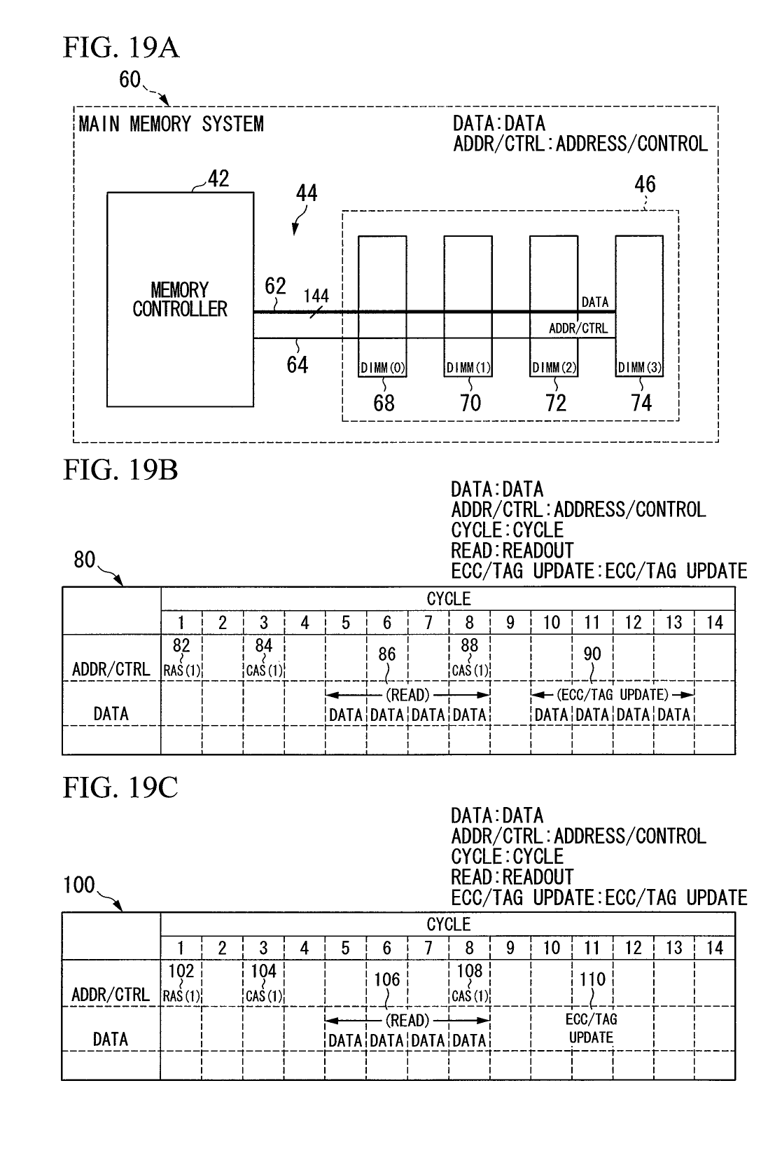

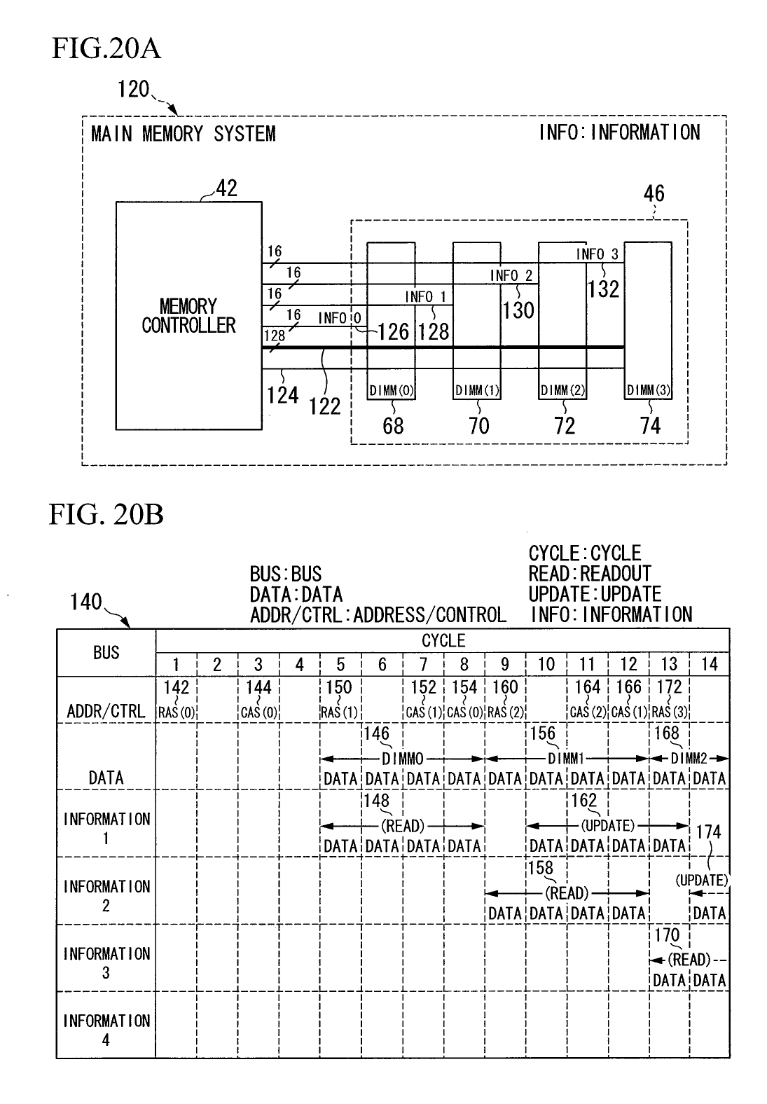

Subsequently, a configuration example of a data process system that includes an external storage device made of the semiconductor memory device of the first embodiment (memory module made of 8 semiconductor memory devices of the present invention) and a multi-core processor (core 1 to core n) will be described hereinafter with reference to FIG. 17. FIG. 17 shows a computer system that includes a multi-core processor and the semiconductor memory device of the first embodiment.

In the present embodiment, the semiconductor memory device plays a role of the external storage device (shared memory) to the multi-core processor. The external storage device has a module configuration that includes 8 semiconductor memory devices of the first embodiment.

An external storage device control unit in a chip of the multi-core processor controls the semiconductor memory devices in the module. That is, the data process system is a computer system, in which the semiconductor memory device is used as a shared memory, a plurality of core processors in the multi-core processor accesses the shared memory, and an operating system can operate. Moreover, the operating system controls access of the multi-core processor to the semiconductor memory device via the external storage device control unit. Furthermore, the operating system controls a plurality of the core processors, and simultaneously controls a plurality of threads.

The external storage device control unit outputs cache line sizes of each multi-core processor to the semiconductor memory device as a command so as to make the size of the unit data region of the data storage region 23 agree with the cache line size of the of the multi-core processor. The external storage device control unit controls three command signals WRC0, WRC2 and WRC2 (command bus) that control writing and reading, in response to control information output from the multi-core processor, so as to access to the data storage region 23 and the information storage region 24.

Alternately, the external storage device is not limited only by the example described above, but may include a plurality of memory modules.

### Third Embodiment

Subsequently, a configuration of a data process system, in which a multi-core processor (core 1 to core n) and an on-chip memory system made of the semiconductor memory device of the first embodiment are formed on one chip, in other words, a system on a chip (SoC), will be described hereinafter with reference to FIG. 18. FIG. 18 shows a computer system that includes the multi-core processor and the semiconductor memory device of the first embodiment.

In the present embodiment, the semiconductor memory device of the first embodiment is an on-chip memory device, and provided on the same chip as described above.

That is, the data process system is a computer system, in which the semiconductor memory device is used as a shared memory, a plurality of core processors in the multi-core processor accesses the shared memory, and an operating system can operate. Moreover, the operating system controls access of the multi-core processor to the semiconductor memory device via an on-chip memory control unit. Furthermore, the operating system controls a plurality of the core processors, and simultaneously controls a plurality of threads.

The on-chip memory control unit, which connects with processor buses (command bus, address bus, and data and information input and output bus), controls the on-chip memory system. The on-chip memory control unit outputs cache line sizes of each multi-core processor to the semiconductor memory device as a command so as to make the size of the unit data region of the data storage region 23 agree with the cache line size of the of the multi-core processor, in a similar way to the external storage device control unit of the second embodiment. The on-chip memory control unit controls three command signals WRC0, WRC2 and WRC2 (command bus) that control writing and reading, in response to control information output from the multi-core processor, so as to access to the data storage region 23 and the information storage region 24.

In this manner, the semiconductor memory device may be made of, for example, an embedded DRAM (eDRAM), or a static random access memory (SRAM) instead of eDRAM. When a memory system with a mass storage capacity is required, it is preferable to employ eDRAM.

According to the embodiments of the present invention as described above, in order to maintain cache coherency in each memory hierarchy, in a memory used for a main memory (in which DRAM is currently used as a main stream), a page, which is selected by a word line, is divided into the data storage region 23 and the information storage region 24, the data storage region 23 is divided into the unit data region whose size agrees with the cache line size, and hence, each unit data region is assigned to each unit information storage region to have a one-to-one correspondence.

The memory hierarchy indicates a hierarchy of a device that stores data, such as a core processor, a cache memory, a main memory, auxiliary storage device, and the like.

The information storage region 24 stores information that relates to the corresponding unit data region (cache line), for example, whether the cache memory stores copy data or not, whether data is valid or not, and the like.

Then, the information storage region 24 automatically comes into accessible at the same time when the corresponding unit data region is accessed. That is, according to the embodiments of the present invention, it is not necessary to separately generate and provide an address as was needed in the conventional art, and hence, there is an advantageous effect in that the configuration of an entire system is simplified.

Thereby, as described above, information, which relates to each cache line, can be stored in the unit information region as a flag, and it is possible to easily access information that is necessary to maintain the cache coherency. For example, these are achieved by hardware.

Alternately, even when those are achieved by software, there is an advantageous effect in that a program is drastically simplified by using the flag.

According to the embodiment of the present invention, since an input and output port of the information storage region 24 (information input and output port 16) has a 1-bit width, there is an advantageous effect in that an increase in a wiring number of a system can be suppressed to the minimum.

Furthermore, according to the embodiment of the present invention, since the data storage region 23 for storing data and the information storage region 24 for storing information are provided in the same memory chip, it is not necessary to add an exclusive memory as was needed in the conventional art, and hence, there is an advantageous effect in that the cost of an entire computer system is reduced and down-sized.

According to the embodiment of the present invention, since the address is input to the data storage region 23 and the information storage region 24, in order to access the data storage region 23, it is possible to simultaneously access the information storage region 24.

Furthermore, since writing in one of the data storage region 23 and the information storage region 24, and reading from the other can be operated simultaneously, control of a system becomes easy.

Therefore, there is an advantageous effect in that it is possible to reduce an access number to the semiconductor memory device, that is, the effective band width of the semiconductor memory device can be increased.

According to the embodiment of the present invention, various information, which relates to the corresponding unit data region (cache line), can be stored in the information storage region 24 of the semiconductor memory device, and various methods can be applied without the limitation by the specified method that maintains the cache coherency of the memory hierarchy.

Therefore, according to the embodiment of the present invention, there is an advantageous effect in that it is applicable to various control methods, which will be necessary in the future, in a system for supporting a multi-thread and a multi-core.

It is apparent that the present invention is not limited to the above embodiments, but may be modified and changed without departing from the scope and spirit of the invention.

Alternately, although the invention has been described above in connection with several preferred embodiments thereof, it will be appreciated by those skilled in the art in that those embodiments are provided solely for illustrating the invention, and should not be relied upon to construe the appended claims in a limiting sense.

What is claimed is:

1. A semiconductor memory device comprising:
a data storage region which includes a plurality of unit data regions storing data;
an information storage region which includes a plurality of unit information regions each storing information related to said data stored in associated one of said unit data regions; and
an address generation circuit which generates an address designating one of said unit data regions and one of said unit information region associated with each other.

2. The semiconductor memory device as recited in claim 1, wherein said address generation circuit generates a first address for designating one of said unit information regions by using a part or an entire of a second address for designating one of said data storage regions.

3. The semiconductor memory device as recited in claim 1, wherein:
said data storage region is divided into said unit data region by a first division number;
said information storage region is divided into said unit information region by a second division number divides; and
said first division number is equal to said second division number.

4. The semiconductor memory device as recited in claim 1, further comprising a mode resister that controls a cache line size of said unit data region.

5. The semiconductor memory device as recited in claim 2, further comprising an address resister that generates said second address.

6. The semiconductor memory device as recited in claim 5, wherein said address resister executes an increment of said second address to access each bit of said unit data region by a burst mode.

7. The semiconductor memory device as recited in claim 6, wherein said address generation circuit executes an increment of said first address to access each bit of said unit information region by said burst mode.

8. The semiconductor memory device as recited in claim 1, wherein said data storage region has a storage capacity larger than that of said information storage region.

9. The semiconductor memory device as recited in claim 1, wherein each of said data storage region and said information storage region independently has an input and output port.

10. The semiconductor memory device as recited in claim 9, wherein said input and output port of said data storage region has a bit width larger than that of said information storage region.

11. The semiconductor memory device as recited in claim 10, wherein said bit width of said input and output port of said data storage region is arbitrary set.

12. The semiconductor memory device as recited in claim 10, wherein said bit width of said input and output port of said information storage region has a 1 bit.

13. The semiconductor memory device as recited in claim 9, further comprising:
a data write-in and readout control circuit that writes and reads said data in and from said each unit data region via said input and output port of said data storage region; and
an information write-in and readout control circuit that writes and reads said information in and from said each unit information region via said input and output port of said information storage region.

14. The semiconductor memory device as recited in claim 13, wherein said data write-in and readout control circuit and said information write-in and readout control circuit write and read, respectively, in synchronization with each other.

15. A data process system comprising:
a memory cell array which includes a data storage region, an information storage region, and an address generation circuit, wherein said data storage region includes a plurality of unit data regions storing data, said information storage region includes a plurality of unit information regions each storing information related to said data stored in associated one of said unit data regions, and said address generation circuit generates an address designating one of said unit data regions and one of said unit information regions associated with each other; and
a multi-core processor which includes a plurality of core central processor units (CPUs), wherein
a cache line size of said core CPU is equal to that of said unit data region in said data storage region.

16. The data process system as recited in claim 15, further comprising a control unit that controls access of said core CPU to said memory cell array, wherein:
each of said plurality of said core CPUs writes and reads said data in and from said memory cell array via said control unit; and
said control unit writes and reads said information in and from said information storage region.

17. The data process system as recited in claim 15, further comprising a plurality of said memory cell arrays.

18. The data process system as recited in claim 15, wherein said memory cell array and said multi-core processor are formed on the same semiconductor substrate.

19. The data process system as recited in claim 15, further comprising an operating system, wherein:
said memory cell array is used as a shared memory; and
said operating system controls access of said plurality of said core CPUs to said shared memory.

20. The data process system as recited in claim 19, wherein said operating system controls said plurality of said core CPUs so as to simultaneously control a plurality of threads.
